(19) United States
(12) Patent Application Publication
(10) Pub. No.: US 2012/0330571 A1
(43) Pub. Date: Dec. 27, 2012

(54) System to measure forces on an insertion device

(76) Inventors: John R. LaCourse, Lee, NH (US); Paula McWilliam, Durham, NH (US)

(21) Appl. No.: 13/135,152

(22) Filed: Jun. 27, 2011

(51) Int. Cl. G06F 19/00; G01L 1/22

(52) U.S. Cl. 702/41; 73/862.627

(57) ABSTRACT

A system to measure forces on a device inserted through the skin into a human or animal body to introduce or remove material.

### FIELD OF THE INVENTION

The present invention relates to a system for the introduction or removal of material from a human or animal body. More specifically, it relates to a system to measure forces on any device with a cannula or other part inserted through the skin into a human or animal body to introduce or remove material.

### BACKGROUND OF THE INVENTION

An insertion device is defined as any device with a cannula or other part inserted through the skin into a human or animal body to introduce or remove material. Such devices include, without limitation, syringes.

Few opportunities are available in the short time medical and nursing students spend in clinical experiences to learn the proper use of insertion devices. Therefore, such students must rely on simulation and didactic information to become proficient and safe in their use. Standard methods developed from evidence-based practice must be available to educators teaching these students. The present invention helps to establish such standard methods by measuring forces on an insertion device during its use.

For example, intramuscular injections using a syringe are considered a “basic skill.” However, the procedure requires a complex series of considerations and decisions specific to trajectory, site selection, volume of medication and drug to be administered. Additional considerations include the patient's age, physical build and pre-existing conditions such as bleeding disorder, and the physical environment where the injection is given. While best-practice guidelines have been published, a standard method for administering medications using a syringe does not exist. Before attempting a study to determine such a standard method, a system designed to measure forces on a syringe during its use is required.

### SUMMARY OF THE INVENTION

The present invention is a system to measure forces on an insertion device, which is any device with a cannula or other part that is inserted through the skin into a human or an animal body to introduce or remove material. It comprises an accelerometer with one or more axes mounted on the insertion device, usually on the body or barrel of the insertion device. In the case of an insertion device with a plunger that must be depressed to introduce material through a haptic interface or raised to remove material, it also comprises a force sensing resistor mounted on the plunger. Data from the accelerometer and force sensing resistor are calculated in a data collection device and subsequently analyzed by a digital computer, which produces, among other things, a graphical representation of the data.

### BRIEF DESCRIPTION OF THE DRAWINGS

The present invention, as well as its advantages, may be better understood by reading the following detailed description of the invention and preferred embodiments and the following drawings in which:

FIG. 1 is a schematic diagram of a preferred embodiment of the present invention;

FIG. 2 is a comparison plot of two sets of accelerometer force data for the x-axis, y-axis and z-axis from a preferred embodiment of the present invention; and

FIG. 3 is a plot of accelerometer force data and force sensing resistor data for the x-axis, y-axis and z-axis from a preferred embodiment of the present invention.

### DETAILED DESCRIPTION OF THE INVENTION AND PREFERRED EMBODIMENTS

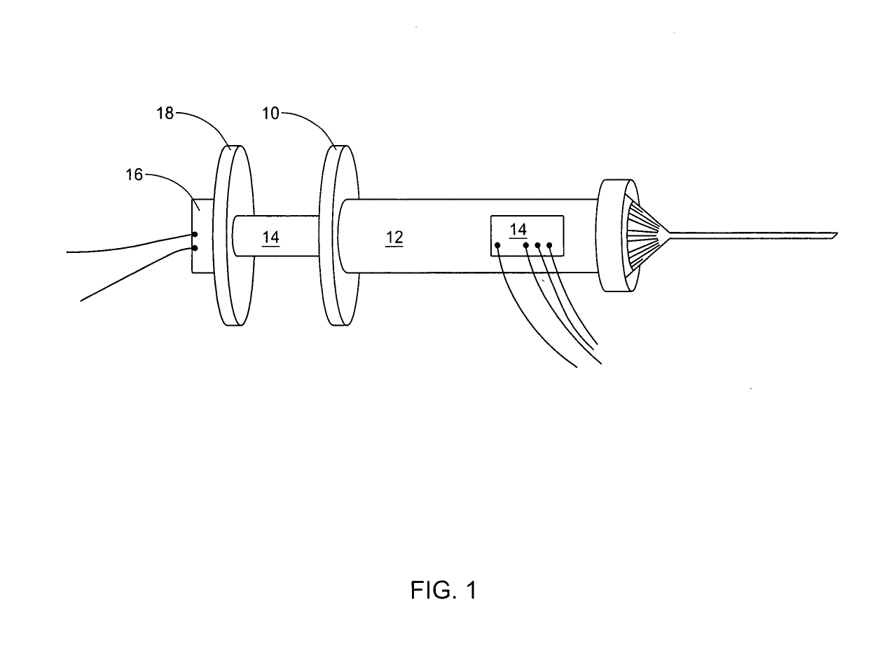

The present invention is a method and apparatus to measure forces on an insertion device during its use. One preferred embodiment of such an insertion device is a syringe, as shown in FIG. 1.

Referring to FIG. 1, a syringe 10 has a barrel 12. A low-g accelerometer 14 is attached to the barrel 12. In this embodiment, a MMA 7260QT low voltage, low current triple axis accelerometer from Freescale Semiconductor is used.

The accelerometer is positioned on the barrel 12 of the syringe 10 so as not to hinder the user's performance during the administration of an injection. The accelerometer has the capability of measuring forces on the syringe 10 along one or more axes. In this embodiment, the accelerometer measures forces along x, y and z axes. The orientation of the x, y and z axes may be specified by the user of the syringe. For example, the user may decide to set the x-axis to mean in/out force directed to the target on the skin, the y-axis to mean up/down with respect to the target on the skin, and the z-axis to mean sideways (left and right) with respect to a target on the skin.

Additionally, an insertion device may have another component such as a plunger that must be depressed to introduce material through the haptic interface or raised to remove material. In FIG. 1, the syringe has a plunger 14 slidably disposed within the barrel 12 that is depressed to introduce material into the human or animal body. A force sensing resistor (“FSR”) 16 is mounted on the first end 18 of the plunger 14, which extends out of the barrel 12. In this embodiment, FSR from Interlink Electronics is used. It is a thin, light-weight resistor with a circular 0.5 inch sensing area. The FSR 16 measures forces on the plunger when the user is depressing the plunger 14 to inject the fluid in the syringe 10. As force is applied, the resistance decreases. It also provides information on the length of time spent actually injecting the fluid and the velocity and acceleration of the fluid being injected.

On other preferred embodiments, the FSR can be re-oriented on the first end of the plunger to measure forces on the plunger when the user is raising the plunger to remove material.

A portable, easy to use data collection device was used to collect, either through a hard wired or wireless connection, and store the data from the accelerometer and the FSR. In this preferred embodiment, a Logomatic v2 Serial SD Datalogger is used to collect data and store it on a MicroSD card. The Datalogger has built-in analog-to-digital convertors, which allow for easy integration of the accelerometer and FSR data. The versatility of its data logging allows for ASCII logging while in the ADC mode. The Datalogger provides a portable method of acquiring and saving a multitude of data logs, limited to only the number and size of the MicroSD card.

After the data is collected, it is analyzed using a digital computer. In this preferred embodiment the data is analyzed and graphed by a digital computer using Matlab software. A Matlab graphical user interface (“GUI”) was created so that necessary calculations can easily be performed and desired graphical representations of the analyzed data can be easily produced. One beneficial graphical representation is a figure that depicts x-axis, y-axis and z-axis data, as defined by the accelerometer, individually graphed versus time on separate plots.

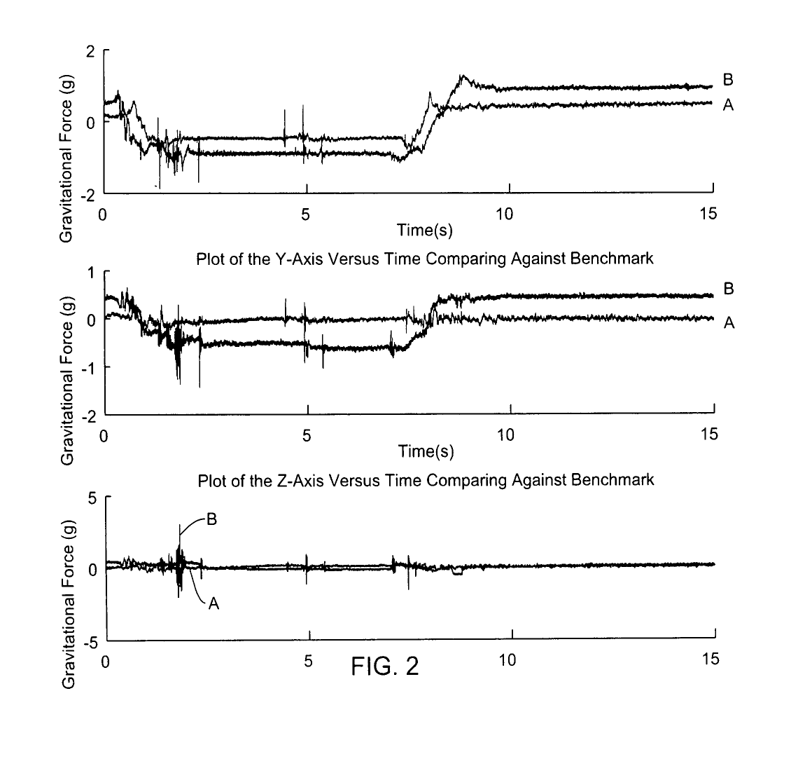

Another function built into the GUI is the capability to compare one set of data to another. This comparison is done both graphically and through output of various statistical calculations performed on the data sets. Graphically, as shown in FIG. 2, the plot of one set of data A is superimposed onto another set of data B, on each of the x-axis, y-axis and z-axis, individually graphed versus time on separate plots, allowing the user to see the differences. As stated, the GUI also has the capability to perform various statistical calculations on the data sets. The user simply clicks the appropriate box and the program outputs a text file containing desired information.

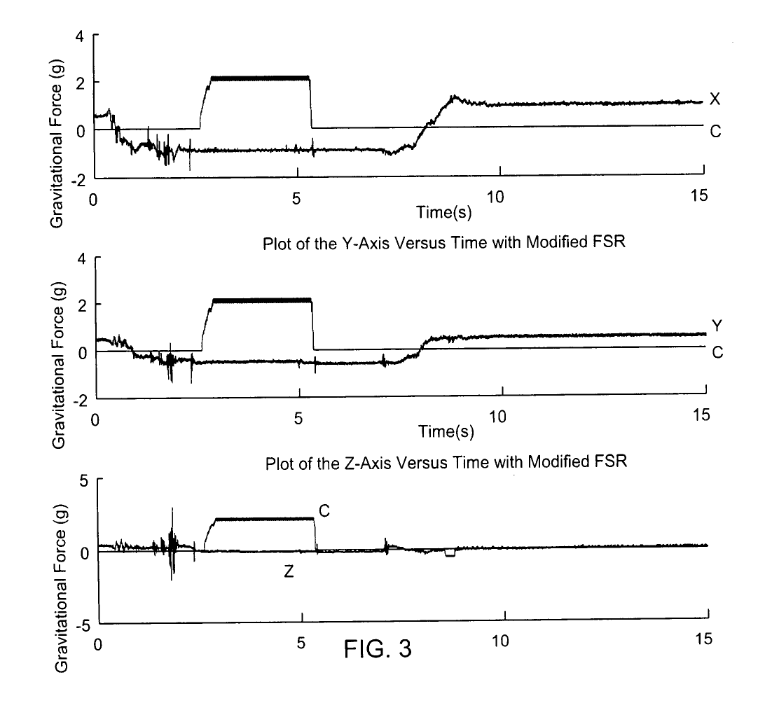

Another beneficial graphical representation depicts the data collected by the FSR. FIG. 3 shows a plot of the data C collected by the FSR superimposed on the x-axis, y-axis and z-axis data (X, Y, Z respectively), as defined by the accelerometer X, Y, Z individually graphed onto separate plots. This provides helpful information. For example, if the user hesitated in giving the injection, the plots would show a large portion of time when the syringe was moved but the plunger was not pushed down to inject the fluid. Finally, if the syringe was moved drastically during the injection, moved side-to-side, up-and-down or in-and-out, this information would be seen in the plot.

In this embodiment, the digital computer also calculates mean, variance, minimum and maximum force by examining the data collected from the accelerometer and the FSR. Maximum positive acceleration indicates the fastest recorded instance when the user moved the needle towards the injection site and maximum negative acceleration indicates the fastest recorded instance when the user moved the needle away from the injection site.

The mean value of the entire data set may not provide much useful insight to the nature of the data, but when examining the time period during the “injection phase,” as seen in FIG. 3, it is extremely important. When the user is injecting fluid, the syringe should not be moving. The GUI provides feedback, telling the user if the syringe moved. It examines the accelerometer and FSR data, determines when the user started the “injection phase.” The computer determines the time period and calculates the mean and compares it to the defined benchmark. Since this calculation is done for each axis of motion, it can be determined in what direction the needle was moved. Ideally, the mean during this time period should be zero, the needle should not move. The user is given the opportunity to learn if the needle moved and in what direction.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. An apparatus for measuring forces on a syringe comprising
a syringe with a barrel and a plunger slidably disposed within the barrel such that a first end of the plunger extends outside the barrel;
an accelerometer mounted on the barrel;
a force sensing resistor mounted on the first end of the plunger; and
a data collection device to collect data from the accelerometer and force sensing resistor.

2. The apparatus of claim 1 further comprising a digital computer to analyze any collected data and to produce a graphical representation of such data.

3. A method for measuring force on a syringe comprising
mounting an accelerometer on a syringe barrel;
mounting a force sensing resistor on a first end of a plunger slidably disposed within the barrel such that the first end of the plunger extends outside the barrel; and
collecting data from the accelerometer and force sensing resistor in a data collection device.

4. The method of claim 3 further comprising analyzing any collected data with a digital computer and producing a graphical representation of such data.

5. An apparatus for measuring forces on an insertion device comprising
an insertion device with a body;
an accelerometer mounted on the body; and
a data collection device to collect data from the accelerometer.

6. The apparatus of claim 5 further comprising a digital computer to analyze any collected data and to produce a graphical representation of such data.

7. A method for measuring forces on an insertion device comprising
mounting an accelerometer on the insertion device; and
collecting the data from the accelerometer in a data collection device.

8. The method of claim 7 further comprising analyzing any collected data with a digital computer and producing a graphical representative of such data.
